(19) United States
(12) Patent Application Publication
(10) Pub. No.: US 2004/0219366 A1
(43) Pub. Date: Nov. 4, 2004

(54) Bright formable metalized film laminate

(76) Inventor: John R. Johnson, Valparaiso, IN (US)

Correspondence Address: CHRISTIE, PARKER & HALE, LLP, P.O. BOX 7068, PASADENA, CA, 91109-7068, US

(21) Appl. No.: 10/429,015

(22) Filed: May 2, 2003

(51) Int. Cl. B32B 27/36

(52) U.S. Cl. 428/423.1; 428/480

(57) ABSTRACT

A process for making a bright metal laminate comprises applying a highly reflective metal layer to a supporting baseweb comprising a flexible thermoplastic and thermoformable polyurethane film. The metal film comprises indium or an alloy of indium and is applied to a surface of the baseweb by vapor deposition techniques. An optically clear polymeric outer layer of preferably acrylic or polycarbonate resin is laminated in free-film form to the exposed surface of the metalized film under heat and pressure to bond the outer layer to the metal film. The surface of the polyurethane baseweb is sufficient to produce adhesion of the metal layer to the baseweb in the absence of an intervening bonding layer or surface treatment, while smoothing out the metal layer to a mirror-like finish that produces a reflective laminate having a DOI greater than 95. The laminate can be thermoformed to a three-dimensional shape while retaining its high level of distinctness-of-image.

### FIELD OF THE INVENTION

This invention relates to bright metalized film laminates, and more particularly, to a formable metal laminate having a high degree of reflectivity, in which the laminate can be thermoformed to a three-dimensional shape while retaining a mirror-like appearance.

### BACKGROUND

Highly reflective metalized polymeric laminates can be used as substitutes for reflective metal parts having chrome-plated surfaces. The automotive industry is an example where decorative metalized polymeric laminates have been used as substitutes for chrome-plated exterior parts such as trim parts, body side moldings, emblems or badges, and the like. Decorative metal laminates also can be used for interior automotive parts such as on dashboards, for example.

Decorative metalized polymeric laminates have been used successfully in the past because plastic parts are relatively flexible, weather-resistant, inexpensive and they can reduce vehicle weight.

In the past, these metalized laminates have been made by metalizing a plastic film and applying protective and supporting or reinforcing layers to form a multi-layer reflective metal/plastic composite. The flexible laminate then can be thermoformed to a three-dimensional shape and subsequently bonded to a molded polymeric substrate sheet.

Some reflective metal laminates are not adequately thermoformable to a three-dimensional shape. Such reflective metal laminates, when formed to a three-dimensional shape, lose their flexibility, causing the metal layer to fracture or suffer loss of reflectivity. Inter-layer adhesion problems such as delamination also can develop during such forming or otherwise during use.

The present invention provides a metalized multi-layer polymeric laminate having a high degree of reflectivity or distinctness-of-image (DOI). The laminate can be thermoformed while still retaining its chrome-like appearance and while maintaining superior inter-layer adhesion.

### SUMMARY OF THE INVENTION

Briefly, one embodiment of the invention comprises a process for making a bright metal laminate which includes applying a highly reflective metal layer to a supporting baseweb layer comprising a flexible thermoplastic and thermoformable polyurethane film. The metal layer comprises indium or an alloy of indium and is applied to the surface of the baseweb by vapor deposition techniques. An optically clear polymeric outer layer preferably containing an acrylic or polycarbonate resin is laminated in free-film form and under heat and pressure to the exposed surface of the metalized film. The lamination step bonds the outer layer to the metal layer but also enhances reflectivity of the metal. The polyurethane baseweb promotes adhesion of the metal layer to the baseweb in the absence of an intervening bonding layer or surface treatment, while lamination smoothes out the metal layer to a mirror-like finish that produces a reflective laminate having a distinctness-of-image greater than 95. The laminate can be thermoformed to a three-dimensional shape while retaining its high level of distinctness-of-image over 95. Highly reflective shaped articles having excellent optical clarity and DOIs over 99 can be produced.

These and other aspects of the invention will be more fully understood by referring to the following detailed description and the accompanying drawings.

### BRIEF DESCRIPTION OF THE DRAWINGS

FIG. 1 is a schematic cross-sectional view illustrating a multi-layer bright metalized film laminate according to principles of this invention.

FIG. 2 is a schematic cross-sectional view illustrating a bright metalized film laminate and molded substrate composite that has been thermoformed to a three-dimensional shape.

FIG. 3 is a schematic cross-sectional view illustrating a three-dimensionally shaped automotive part having a reflective metal surface and a molded substrate.

### DETAILED DESCRIPTION OF THE INVENTION

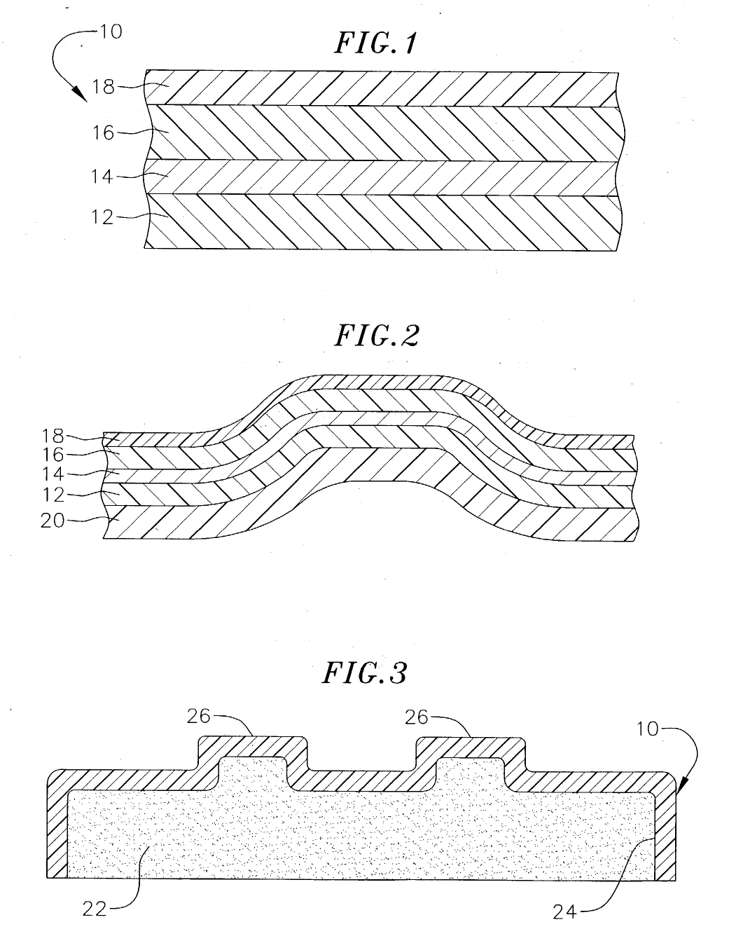

FIG. 1 illustrates a bright metalized film laminate 10 according to principles of this invention. The laminate can be thermoformed into a three-dimensional shape and still retain a highly reflective chrome-like appearance. The laminate comprises a flexible thermoformable and thermoplastic polymeric baseweb layer 12, a reflective metal layer 14 bonded to the baseweb layer 12, and an optically clear polymeric outer layer or top layer 16 bonded to the side of the metal layer opposite from the baseweb. An optional protective polymeric over-laminate 18 can be bonded to the outer surface of the top layer.

The clear outer layer 16 comprises a flexible self-supporting sheet or film of a thermoformable and thermoplastic polymeric material. The preferred thermoplastic materials contain polycarbonate or acrylic resins. The outer layer comprises a continuous sheet or film having high temperature resistance sufficient for withstanding lamination under heat and pressure and thermoforming sheet temperatures as described below. The acrylic outer layer preferably has a thickness in the range from about 2.5 to 20 mils. The polycarbonate layer can have a thickness in the range from about 7 to 20 mils. Generally speaking, the thicker the clear outer layer, the better the metallic appearance of the final laminate, following the lamination step described below. The clear outer layer is sufficiently semi-rigid to provide a reinforcing layer for subsequent thermoforming, lamination and molding steps. The outer layer is sufficiently thermformable to be capable of retaining a three-dimensional shape after the composite sheet material is thermoformed at temperatures raising the sheet temperature of the laminate to 330° to 370° F. The outer layer also is optically transparent and essentially gel free to enhance the optical properties of the bright metal laminates.

In one embodiment, the preferred sources of the acrylic outer films are high gloss polymethylmethacrylate resins identified as Sumitomo S001, Kaneka SD009 or SD010 and Mitsubishi Rayon N47. The preferred polycarbonate film is Bayer DE1-1.

The metal layer 14 is applied to the baseweb 12 by vapor deposition techniques. The metal layer preferably comprises indium but also can include alloys of indium, such as indium/tin or indium/silver alloys, and in some applications tin can be used. Indium (and alloys with a high indium content) have a more desirable chrome-like appearance. Indium is also preferred because it is a soft metal having a melt temperature of about 155° C. (311° F.)which causes the layer of indium to flow properly during the lamination and thermoforming steps described below. Indium has a melt point that allows it to flow during lamination to deform at thermoforming temperatures (330-370° F.) and still maintain a chrome-like appearance.

The metal layer is formed on the baseweb as a continuous thin film of uniform thickness. As mentioned, the metal layer is preferably deposited by vapor deposition techniques, typically by applying a molten metal under vacuum by such techniques as electron beam evaporation, sputtering, induction heating, or thermal evaporation. All of these deposition techniques are referred to generally as vapor deposition. The metal is deposited at a layer thickness that forms a continuous metal film, one in which the metal is initially deposited as closely spaced discrete metal islands but further deposited or allowed to spread out to such an extent that the layer becomes an uninterrupted thin reflective metal film. The indium is preferably deposited at a layer thickness of 1.0 gram per square meter or less. Stated another way, the indium layer thickness ranges from about 200 to about 1,600 angstroms, more preferably, about 400 to about 1000 angstroms.

The indium film is applied to achieve a highly reflective, optically continuous metallic appearance. The objective is not to achieve an opaque metal layer because indium, when applied too thick, can have a cloudy appearance. Preferably, optical density is the parameter to be measured for adjusting to achieve a desired metal film thickness; and in one embodiment, desired optical density is from about 0.6 to about 1.6, and more preferably, about 1.0 to about 1.3, when measured on a MacBeth model TR927 densitometer.

The thickness of the metal film also can be characterized by its visible light transmittance. In one embodiment of the invention, the visible light transmittance of the metal film was measured across the range of the visible spectrum: approximately 400 to 700 nm wavelength. At 700 nm the light transmittance was about 14%; at 400 nm the light transmittance was about 2%. The light transmittance increase was almost linear between the 400 and 700 nm end points.

In some embodiments involving films of greater thickness within the 200 to 1,600 angstroms range, the visible light transmittance of the film is more desirably within the 2% to 8% range where the metal film tends to undergo thinning in higher draw applications.

The baseweb layer comprises a flexible thermoplastic and thermoformable film or sheet of polyurethane resin. Generally speaking, the polyurethane layer has several advantages with respect to metalization, lamination and thermoforming. In one embodiment, the polyurethane baseweb has a surface roughness and the surface of the polyurethane baseweb is inherently tacky, which results in excellent metal adhesion. The metal is applied in direct contact with the tacky surface of the polyurethane baseweb. No corona or plasma treatment or adhesive layers are necessary to enhance adhesion of the metal film. The metalized urethane surface still retains some tackiness which helps in subsequent lamination to the top layer as described below. Although the urethane has a high surface roughness during the metalization process, it smoothes to a mirror-like surface during the applied heat and pressure of the lamination process. The urethane film is very flexible which enables it to easily assume a three-dimensional shape during thermoforming, and the composite construction of the top layer/metal layer/urethane layer has excellent intercoat adhesion. The peel strength at the interface of the metal film and the outer layer is greater than 10 pounds per inch, and in one embodiment, the peel strength is in excess of 40 pounds per inch.

More specifically, one embodiment of the urethane baseweb film has a high coefficient of friction sufficient to produce the tacky deposition surface. The surface of the otherwise continuous layer of vapor deposited indium has many surface “peaks and valleys” when viewed on a microscopic scale. The surface is characterized as fairly bumpy at the microscopic level but is not composed of discrete islands which are separated or isolated from each other. Microphotographs have shown that the surface of the indium metalized on a smooth surface of a PET film also is characterized by peaks and valleys. The surface roughness of the baseweb causes improved adhesion of the metal to the underlying urethane baseweb film, and as mentioned, no surface treatment or adhesive tie coat layers are necessary to achieve sufficient bonding of the metal to the urethane layer. The heat and pressure of lamination (described below) causes the metal layer to flow and smoothes the metal layer to a mirror-like surface having a DOI in excess of 99. DOI of the initial metalized surface can be as low as 60 prior to lamination.

The preferred thickness of the polyurethane baseweb layer is from about 2 to about 8 mils. The polyurethane baseweb is preferably supported by a polyester (PET) carrier film which allows better processing during metalization and subsequent lamination.

The presently preferred polyurethane baseweb material is an extrusion grade thermoplastic urethane resin film. The preferred urethane baseweb material is an optically clear sheet stock film made by Deerfield Urethane, a Bayer company, South Deerfield, Mass., Product No. A3600, an aliphatic polyester polyurethane film having a Shore A hardness of 92, a peak melting point of 98° C. (208° F.), a glass transition temperature of −16° C., and an ultimate elongation of 550%. Peak melting point is measured by DSC (Differential Scanning Calorimeter) and T_{g} is measured by TMA (Thermal Mechanical Analysis). An alternative source of the urethane film is J. P. Stevens, Product No. SS-1219.

In one embodiment, the glass transition temperature (T_{g}) of the polyurethane baseweb is below about 0° C. The melt temperature is between about 90° and about 110° C. The baseweb can flow with the other layers during the thermoforming process and the metalized baseweb has good adhesion to the polycarbonate or acrylic outer layers during lamination and thermoforming. The T_{g} of this particular baseweb material also enhances adhesion to the metal film. The baseweb material has a Shore A hardness above 80 and more preferably above 85, which provides better adhesion than similar urethane films of lower hardness. The combined properties of the aliphatic polyester urethane film provide a desirable combination metal adhesion, clarity, hardness and thermoformability.

The clear outer layer 16 is laminated to the exposed outer surface of the metalized urethane baseweb. As mentioned, the lamination step bonds the metal layer to the underside of the clear outer layer and smoothes the metal to produce a DOI in excess of 99. Melting or flow of the polymer layers and metal layer most likely occurs during lamination, which smoothes the metal layer to its highly reflective chrome-like appearance. In one embodiment, a hot roll temperature of at least 400° F. and a roll pressure of about 700 pounds per square inch are used for the lamination step. In some instances, an adhesive tie coat layer may be used between the metal layer and the outer layer to improve adhesion.

The protective over-laminate 18 can be permanently bonded to the outer surface of the polycarbonate clear outer layer 12. The over-laminate can improve outdoor weathering properties of the polycarbonate layer. A polyvinylidene fluoride/acrylic (PVDF/acrylic) alloy film has been found to be effective as an over-laminate, especially in retarding yellowing of the polycarbonate. The preferred thickness of the PVDF/acrylic over-laminate is about 0.5 to about 2.0 mils. A small amount (2 phr or less) of UV absorber can be dispersed in the over-laminate. The over-laminate also can resist loss of gloss in the polycarbonate outer layer. The over-laminate can be adhered to the outer layer by an intervening adhesive tie coat layer. The acrylic clear outer layer can be used without such an over-laminate since it typically has inherently better weathering resistance than the polycarbonate.

The over-laminate can be tinted with an appropriate level of pigment to provide coloration in certain applications. The over-laminate also can have one or more undercoated print layers for various desired print designs.

The laminate 10 of FIG. 1 can be thermoformed to a three-dimensional shape as illustrated in FIG. 2. The thermoforming tool (not shown) applies heat and pressure to vacuum-form the laminate to a three-dimensional shape, causing elongation of the metal and polymer layers to produce the desired shape. The preferred sheet temperature of the laminate during thermoforming is between about 330° to about 370° F. The appearance of the finished part is improved when the urethane baseweb is formed against the face of the thermoforming tool. The composite laminate can stretch up to at least 100% during thermoforming without suffering any fracture in the metal layer or otherwise degrading its DOI level. Tests have shown that DOI of the laminate is maintained above 95 during the thermoforming step and finished shaped parts have DOIs in excess of 99.

The rigidity of the polycarbonate or acrylic outer layer provides a reinforcing sheet that assists in thermoforming the laminate to a finished three-dimensional shape. The melt temperatures of the metal layer and polyurethane baseweb are lower than the thermoforming sheet temperature, causing the metal and urethane to flow at the interfaces sufficiently to form a good bond at each interface. The T_{g} and melt temperature characteristics of the urethane baseweb also enhance stretching of the baseweb during thermoforming, while the metal layer elongates properly to maintain its highly reflective, high DOI optical properties. The thickness of the formed outer layer also enhances DOI of the finished shaped laminate.

In subsequent operations, a supporting substrate sheet 20 can be molded and bonded to the urethane baseweb side of the formed laminate to produce a finished part. The substrate sheet material comprises a molded polymeric resin such as ABS, polycarbonate, thermoplastic elastomer such as thermoplastic polyolefin or thermoplastic urethane, or acrylic resin, which can be injection molded to the thermoformed laminate, for example, in an insert-mold process. Certain adhesive coatings can be applied to the underside of the urethane baseweb to enhance adhesion to the substrate sheet. For instance, CPO adhesives can be used to bond the laminate to a TPO substrate sheet. In one embodiment, peel strength at the interface of the baseweb and substrate sheet is more than about 8 pounds per inch. Release coat materials also can be applied to the exposed surface of the urethane baseweb to allow better release from a thermoforming mold.

Alternatively, the molded substrate resin material can be poured into the thermoformed cavity of the previously shaped laminate to form a structural base for an automotive part. An adhesive can be applied later for making finished shaped parts such as automotive emblems or badges. In this embodiment, a crosslinkable urethane resin, a thermoplastic elastomer, or an acrylic resin can be used as the substrate resin sheet material.

FIG. 3 illustrates such an alternative use of the invention in which the bright metal laminate 10 has been thermoformed to a three dimensional shape and bonded to a molded substrate material 22. In this embodiment, thermoforming of the laminate first forms a cavity 24 on the underside of the shaped laminate. The top surface of the laminate in FIG. 3 is shown in cross-section with projected areas 26 forming a shaped exterior design for the finished part, such as an automotive badge or emblem. The shaped laminate is then inverted and the molding material in fluid form is poured into the cavity to fill the void and form a more rigid substrate after hardening or curing of the molding material. An adhesive layer (not shown) such as a pressure sensitive adhesive can be applied to the bottom face of the molded substrate for use in attaching the badge or emblem to an automobile body or the like.

Further details on the process and construction of the automotive badge of FIG. 3 are described in a U.S. patent application entitled “Three Dimensional Automobile Badge,” inventor John Richard Johnson, which is incorporated herein by this reference. This application is assigned to the assignee of the present application and has the same filing date as the present application, with an Express Mail No. EV164825330US.

The bright metalized finished part can be used for other exterior automotive applications, such as automotive trim parts, body side moldings and grills. The finished part also can be used for interior automotive trim applications.

### EXAMPLES

An 8 mil urethane sheet supported on one side by a polyester carrier was placed in a bell jar vacuum metalization apparatus. A 0.06 gram piece of indium was then placed in an evaporation boat. A vacuum was drawn and an electric current was applied to the evaporation boat. The indium piece melted by vaporization and was deposited on the urethane sheet. The vacuum chamber was vented and the sample removed. Urethane sheets of 2, 3 and 6 mil thickness were also used successfully in this process.

A clear sheet of thermoplastic material such as polycarbonate or acrylic resin was cut to the same size as the 8 mil urethane sheet. A thickness range of the clear sheet was between 10-20 mils although the acrylic as thin as 2.5 mils has been used successfully. For the polycarbonate sheet a PVDF/acrylic over-laminate was laminated to the outer surface. The metalized side of the urethane sheet was placed on the clear sheet of acrylic or polycarbonate. A laminating roll applied heat and pressure and was then passed over the PET-supported side of the urethane. This caused a permanent bond between the metalized side of the urethane and the clear sheet of polycarbonate or acrylic.

The resulting clear sheet/metal layer/urethane composite laminate was then placed in a thermoforming apparatus with the clear layer facing up. The sample was heated and a vacuum was drawn on the urethane side. The resulting product had a chrome-like appearance with a DOI greater than 99. DOI was measured on instrument Model No. 1864 SQC from ATI Systems Inc.

Measurements were taken of the 180 peel strength at two interfaces: urethane-to-injection molded ABS and polycarbonate-to-metalized urethane. The urethane-to-ABS bond was measured as 10.87 pounds per inch and the polycarbonate-to-metalized urethane bond was measured at 44.98 pounds per inch. Some of the high reading for the polycarbonate-to-metalized urethane maybe have been attributable to the energy required to deform the polycarbonate at a 180° angle during the test. However, both interfaces had a very strong bond. It has been found that the somewhat rigid thick top layers of the laminate provide more depth of image and a thicker protective layer for the metal layer and are harder to remove.

What is claimed is:

1. A process for making a bright metal laminate comprising an optically clear polymeric outer layer, a highly reflective metal layer on the underside of the outer layer and visible through the outer layer, and a supporting baseweb layer to which the metal layer is applied, the baseweb comprising a flexible thermoplastic and thermoformable polyurethane film, the metal layer comprising indium or an alloy thereof, the process comprising vapor-depositing the metal layer on a surface of the baseweb to form an essentially continuous layer of reflective metal on the baseweb, and laminating the outer layer under heat and pressure to the exposed surface of the metal layer to bond the outer layer to the metal layer, the lamination step causing the polyurethane baseweb to produce adhesion of the metal layer to the baseweb in the absence of an intervening bonding layer or surface treatment while smoothing out the metal layer to a mirror-like finish and producing a reflective laminate having a distinctness-of-image greater than 95 when viewed through the clear outer layer.

2. The process according to claim 1 in which the thickness of the baseweb layer is from about 2 to about 8 mils.

3. The process according to claim 1 in which the baseweb is an extruded free film.

4. The process according to claim 1 in which the baseweb has a Shore A hardness of greater than 80; a T_{g} below about 0° C., and a melt point between about 90° and 110° C.

5. The process according to claim 1 in which the baseweb is an aliphatic polyester polyurethane film.

6. The process according to claim 1 in which the baseweb has a microroughened, tacky deposition surface on which the metal layer is vapor deposited.

7. The process according to claim 1 in which the metal layer has a thickness from about 200 to about 1,600 angstoms.

8. The process according to claim 1 in which the outer layer is a semi-rigid sheet having a thickness from about 2.5 to about 20 mils.

9. The process according to claim 8 in which the outer layer comprises acrylic or polycarbonate resin.

10. The process according to claim 1 in which the laminate includes an over-laminate comprising a film of polyvinylidene fluoride and acrylic resin alloy bonded to the outer layer.

11. The process according to claim 1 in which the lamination temperature is greater than the melt temperature of the metal layer and the melt temperature of the baseweb layer.

12. The process according to claim 1 in which the metal layer has an optical density from about 0.6 to about 1.6.

13. The process according to claim 1 in which the peel strength at the interface of the metal layer and the outer layer is greater than about 10 pounds per inch.

14. The process according to claim 1 including thermoforming the laminate to a three dimensional shape while the finished laminate retains the DOI at greater than 95.

15. The process according to claim 14 in which the thermoforming step causes elongation of the laminate in excess of 100% while retaining the DOI at greater than 95.

16. The process according to claim 14 including thermoforming the laminate at a sheet temperature between 330 to 370 degrees F.

17. The process according to claim 14 including molding a polymeric substrate material to a thermoformed baseweb to form a three-dimensionally shaped part.

18. The process according to claim 17 in which the interlayer bond strength between the baseweb and the molded substrate layer is greater than about 8 pounds per inch.

19. The process according to claim 17 in which the substrate material is bonded to the baseweb material by injection molding.

20. The process according to claim 17 in which the polymeric substrate material is bonded to the formed baseweb by backfilling the substrate material in a pouring operation.

21. A bright metal film laminate comprising an optically clear polymeric outer layer, a highly reflective metal layer bonded to the underside of the outer layer and visible through the outer layer, and a flexible supporting baseweb to which the metal layer is bonded, the baseweb comprising a flexible thermoplastic and thermoformable polyurethane film, the metal layer comprising indium or an alloy thereof in direct contact with the polyurethane baseweb, the metal layer vapor deposited on the baseweb to form an essentially continuous layer of reflective metal on the baseweb, the outer layer comprising a thermoplastic and thermoformable film containing polycarbonate or acrylic resin, in which the outer layer is a semi-rigid sheet or film having a thickness from about 2.5 to about 20 mils, the outer layer bonded to the metal layer by lamination under heat and pressure sufficient to smooth the metal layer to a mirror-like finish producing a DOI greater than 95 when the laminate is viewed through the clear outer layer.

22. The laminate according to claim 21 in which the polyurethane baseweb comprises an aliphatic polyester polyurethane resin.

23. The laminate according to claim 21 in which the peel strength at the interface of the metal layer and the outer layer is greater than 10 pounds per inch.

24. The laminate according to claim 21 in which the baseweb has a Shore A hardness of greater than 80; a T_{g} below about 0° C., and a melt point between about 90° and 110° C.

25. The laminate according to claim 21 in which the baseweb has a microroughened, tacky deposition surface on which the metal layer is vapor deposited.

26. The laminate according to claim 21 in which the metal layer has a thickness from about 200 to about 1,600 angstoms.

27. The laminate according to claim 21 in which the outer layer comprises acrylic or polycarbonate resin.

28. The laminate according to claim 21 in which the metal layer has an optical density from about 0.6 to about 1.6.

29. A bright metal film laminate comprising:
a flexible thermoplastic and thermoformable aliphatic polyurethane baseweb having a T_{g} below about 0° C. and a melting temperature between about 90° to 110° C.,
a metalized layer of indium or an alloy thereof vapor deposited as an optically continuous film and bonded in direct contact with the polyurethane baseweb, the metal layer having a thickness from about 200 to about 1,600 angstroms, and
a flexible thermoplastic and thermoformable clear outer layer comprising a polymeric material containing polycarbonate or acrylic resin bonded by lamination to the outer surface of the metal layer opposite the baseweb,
the outer layer having a thickness from about 2.5 to about 20 mils to provide sufficient rigidity for transforming the laminate to a three-dimensional shape,
the laminate having a DOI of at least about 95 when viewed through the clear outer layer.

30. The laminate according to claim 29 in which the polyurethane baseweb comprises an aliphatic polyester polyurethane film.

31. The laminate according to claim 30 in which the peel strength at the interface of the metal layer and the outer layer is greater than 10 pounds per inch.

32. A shaped article comprising a bright metal film laminate and polymeric substrate composite forming a three-dimensional shaped article, the bright metal film laminate comprising an optically clear polymeric outer layer, a highly reflective metal layer bonded to the underside of the outer layer and visible through the outer layer, and a flexible supporting baseweb to which the metal layer is bonded, the baseweb comprising a flexible thermoplastic and thermoformable polyurethane film, the metal layer comprising indium or an alloy thereof in direct contact with the polyurethane baseweb, the metal layer vapor deposited on the baseweb to form an essentially continuous layer of reflective metal on the baseweb, the outer layer comprising a thermoplastic and thermoformable film containing polycarbonate or acrylic resin in which the outer layer is a semi-rigid sheet or film having a thickness from about 2.5 to about 20 mils, the outer layer bonded to the metal layer by lamination under heat and pressure sufficient to smooth the metal layer to a mirror-like finish producing a DOI greater than 95 when the laminate is viewed through the clear outer layer, and a polymeric substrate sheet or layer bonded to the side of the baseweb opposite from the metalized layer, the metal film laminate having been thermoformed to a three-dimensional shape while the exposed outer surface of the metal film laminate retains its DOI level of 95 in the finished shaped article.

33. The laminate according to claim 32 in which the baseweb comprises an aliphatic polyester polyurethane film.

34. The laminate according to claim 32 in which the melting temperature of the polyurethane baseweb is below about 330° F.

35. The shaped article according to claim 32 in which the shaped article comprises an exterior automotive trim part.

36. The shaped article according to claim 32 in which the shaped article comprises an exterior automotive badge or emblem, in which the substrate layer comprises a moldable polymeric material molded to conform to the shape of the thermoformed metal film laminate.

37. The shaped article according to claim 36 in which the molded polymeric resin substrate material comprises a cross-linked polyurethane resin, a thermoplastic elastomer, or an acrylic resin.

38. An automotive badge or emblem comprising a shaped bright metal laminate forming at least a portion of a viewable surface of the badge or emblem and a structural base for supporting the shaped laminate, in which the shaped laminate has a bottom surface forming a cavity, and the structural base is formed by a hardened molded polymer material contained in the cavity, the bright metal laminate comprising an optically clear polymeric outer layer, a highly reflective metal layer on the underside of the outer layer and visible through the outer layer, and a baseweb layer to which the metal layer is applied, the baseweb comprising a flexible thermoplastic and thermoformable polyurethane film, the metal layer comprising indium or an alloy thereof, the metal layer vapor deposited on the baseweb to form a visually continuous layer of reflective metal on the baseweb, the outer layer bonded to the metal layer by lamination sufficient to smooth the metal layer to a mirror-like finish, and in which the bright metal laminate has been thermoformed to form the cavity on the baseweb side of the laminate for containing the molded substrate material.

39. The article according to claim 38 in which the thickness of the baseweb layer is from about 2 to about 8 mils.

40. The article according to claim 38 in which the baseweb has a Shore A hardness of greater than 80; a T_{g} below about 0° C., and a melt point between about 90° and 110° C.

41. The article according to claim 38 in which the baseweb is an aliphatic polyester polyurethane film.

42. The article according to claim 38 in which the metal layer has a thickness from about 200 to about 1,600 angstoms.

43. The article according to claim 38 in which the outer layer is a semi-rigid sheet having a thickness from about 2.5 to about 20 mils.

44. The article according to claim 38 in which the outer layer comprises acrylic or polycarbonate resin.

45. The article according to claim 38 in which the metal layer has an optical density from about 0.6 to about 1.6.

46. The article according to claim 38 in which the three-dimensionally shaped laminate has a DOI greater than 95.
